(19) United States
(12) Patent Application Publication
(10) Pub. No.: US 2006/0242868 A1
(43) Pub. Date: Nov. 2, 2006

(54) Method and corresponding label for labelling

(75) Inventor: Junichi Kobayashi, Cambridgeshire (GB)

Correspondence Address: RICHARD M. GOLDBERG, 25 EAST SALEM STREET, SUITE 419, HACKENSACK, NJ, 07601, US

(73) Assignee: Ko-Pack International (Eurpope) Limited, Orton Southgate, Peterbouough (GB)

(21) Appl. No.: 10/556,380

(22) PCT Filed: Apr. 30, 2004
(86) PCT No.: PCT/GB04/01892

§ 371 Date: Nov. 10, 2005

(30) Foreign Application Priority Data
May 16, 2003 (GB) 0311286.9
Dec. 23, 2003 (GB) 0329624.1
Mar. 23, 2004 (GB) 0406496.0

(51) Int. Cl. G09F 3/00

(52) U.S. Cl. 40/306

(57) ABSTRACT

A label (10) and method of labelling applicable to the labelling of bottles for carbonated beverages, such as cola, provides a label (10) in which an inner label portion identifies the product and invites the user to gain access thereto via a removable tamper-resistant transparent outer label portion (22). In-use the entire label assembly (10) is removed by the user in the course of gaining access to internal information, thereby fitting the bottle for recycling. The label assembly is rendered capable of resisting the tension applied during bottling and after bottling by constructing the label as homogeneous laminar assembly comprising polypropylene/polypropylene layers of differing densities, whereby the stretch characteristics enable the label to accommodate these tension loads.

This invention relates to a method and a corresponding label for labelling. An example of the application of the invention is to labels for use in relation to labelling bottles of beverages such as cola-type beverages and mineral waters and many other soft drinks and the like. However some aspects of the invention are by no means limited to such uses, and are suitable for application to many types of packaging applications of consumer products and other products.

Methods and corresponding labels proposed for use in such applications are extremely numerous and include labels which are permanent in terms of their attachment to the product, and those which are peelable, and those having peelable portions.

In the case of labels of the general kind to which the invention relates, we have identified a need for an ability to provide for product promotions of various kinds, and for an ability to accommodate the requirements for recycling of the product, and for an ability to provide a degree of resistance to tampering with the promotional aspects of the label (where such are provided), and for an ability to accommodate dual usage of the label, in the sense of the provision of a label which not only meets the obvious need to identify the product carrying it, but which is able simultaneously to fulfil the other functions identified herein.

An object of the present invention is to provide a method and a corresponding product in the form of a label which offer improvements in relation to at least on or more of these criteria, or improvements generally.

According to the invention there is provided a label and a corresponding method of labelling comprising a combination of the features disclosed herein.

In an embodiment of the invention there is provided a method of labelling in which there is provided a label, which is detachably applied to a corresponding product. Usually the label will be secured detachably to the product by a peelable adhesive, but it is envisaged that certain applications of the invention could use non-peelable methods of securing the label to the product, such as the use of a tension-fit or friction-fit for one portion of the label and a peelable securing system for the remainder of the label.

In the embodiment, the label is applied to the product so as to be detachable by the user. Typically, but not exclusively, the label is peelably adhered to the product. Then the product is distributed to its end user, for example by sale or other mode of distribution, so that the label and its product are brought, in due time, to their place of use and/or consumption. In the case of the typical product for which the described embodiments are intended, the label is applied to a bottle for a soft drink, such as a well-known Cola-type non-alcoholic beverage.

In the thus-labelled state of the product, the user/consumer of the product will usually have displayed to him/her the nature and/or name/trade mark of the product, or some other means for identifying it, so that, as a consumer/user, that person has sufficient information for usage/consumption purposes. The invention is not limited in any way by the nature or content of such data or information, and for the purposes of the broader aspects of the invention it is sufficient that the label fulfills merely the minimum aspects of a label as such.

Accordingly, the end user of the beverage may then consume the beverage according to his/her needs and preferences, or the user may decide to postpone such consumption until later. Whether or not such postponement occurs, the label offers to the user or consumer the ability to peel or otherwise open the label so as to reveal further data or information relevant to the product and/or relevant to an option available to the user or consumer, such as entry to a game of chance such as a lottery draw.

Typically, such peeling of the label is effected by the user cutting the label at an indicated cut line on the label, whereby the user can cut the label in one direction or dimension (for example across the width of the label), so that such cutting (by scissors for example) causes the label to be able to be peeled-back or otherwise removed or partially-removed from its attached position, thereby to cause separation of first and second peelable (or otherwise selectively removable from the product) portions of the label.

The first removable label portion is the portion which the user uses to apply the peel-causing forces to the label, and it is thus (in the embodiment) peeled-back and away from the product (typically a bottle), thereby causing the second removable portion to be separated from the first such portion. Such separation is caused in the embodiment by the provision of die-cut separation of the label portions in their manufacture, while these label portions are nevertheless connected as a sufficiently strong and coherent label structure by the additional provision of label-portion-linking means in the form of a web or strip or lengthwise label element of (in this embodiment) a transparent film of polymeric film (adapted to the use in hand). The label-portion-linking means forms part of the first label portion and overlies the second label portion, and (because it is transparent, or it could be merely translucent) it also provides visual access for the user to the second label portion, so that the user is able to see the second label portion before its separation from the first portion, whereby printed matter or other indicia or markings on the second portion serve (prior to separation) effectively to identify the product and/or its contents and/or to provide other useful or interesting information for the user or consumer, prior to separation of the label portions.

It will now also be apparent that the separability of the label portions, and their relative visual relationship as discussed above, leads to the result that after separation of the label portions, the printed matter or other indicia or markings on the second portion can now also serve (after separation), as indeed they did prior to separation effectively to identify the product and/or its contents and/or to provide other useful or interesting information for the user or consumer, after separation of the label portions. In other words, the arrangement in the embodiment is that the separable second label portion can serve both before and after separation from the first label portion as means for carrying and showing any desired marking or indicia. As a result, the second label portion serves several functions in the embodiment.

Of these several functions, there is the first function of providing the above-discussed indicia or other markings for the product, both before and after peeling of the first label portion. Then, in addition, there is the function of forming, prior to peeling of the first label portion, an integral and coherent part of the entire label structure due to the overlying positional relationship of the first label portion, linking the two label portions and due (in the embodiment) to the use of peelable adhesive on the inner face of the first label portion, which serves to hold the second label portion to the first label portion prior to peeling.

Then, in addition to the above-discussed first function of the second label portion, there is the function of serving (after separation of the label portions) to remain attached to the product and (if so desired by the product maker) to identify the product (which may not necessarily have been consumed at this stage), for a further period of time.

Such attachment of the second label portion to the product after separation of the label portions can be achieved, as in the embodiment, by arranging that the under or inner side of the second label portion (and usually it will also, but not necessarily so, be the case that the label first portion is likewise treated) is treated with peelable adhesive or some comparable treatment to cause it to be able to be separably attached to the product.

Thus, the label second portion serves, in the embodiment, both prior and after separation from the first label portion to identify the product or to provide some other desired information, and it can itself also be peelably (or otherwise optionally) removed from the product in a convenient manner by an end-user or other user, and for a purpose now to be discussed.

It will be apparent from, or at least it can be determined from, the above that the label system under discussion herein is able to label a product and to provide a peelable or otherwise removable first portion giving access to and meanwhile protecting the interior of the label. The label at all times so far discussed (except on removal, if such is provided in any given embodiment, of all label portions) provides the ability to label or identify (if such is required by the manufacturer) the product. However, the label is able also to provide a further function which has not hitherto been discussed at any length herein, and which serves to give the product significant additional versatility. This latter function is to offer the user access to additional information, after separation of the label portions, which additional information offers (if so desired by the product manufacturer or distributor), functions or facilities which are specifically not available (and will usually be hidden or at most only hinted at) until such separation of the label portions.

An example of such functions or facilities is access to a lottery or like game of chance, or related systems for the user to test his/her luck/skills/dexterity/knowledge or other qualities with a view to winning a prize of some kind. Thus, typically the label of the embodiment could offer the user access to a lottery or the like as an additional inducement to buy the product, and such is available to the purchaser only after purchase since access to the lottery is achieved by peeling (or otherwise separating) the first and second label portions, whereby the user or consumer can (after such separation) then go on to peel (or otherwise remove from the product) the second label portion, so as to reveal the information or data or the like relating to the lottery or the like which is provided at the underside of the second label portion. It will be well understood by those skilled in the art of such games of chance that it is by no means essential for the aforesaid information or data or the like relating to the lottery or the like to be necessarily provided at the underside of the second label portion. For example, it would be entirely possible for it to be provided at the side of the second label portion which, in use, is exposed visually through (in the embodiment) the transparent window provided by the first label portion), but is in the format of a so-called scratch card system, whereby the data is not available until the user carries out the necessary “scratching” operation. And it will equally be understood that such “scratching” operation is not (in the embodiment) possible until the first label portion has been peeled or otherwise removed from the second label portion.

A further option for the peelable second label portion is to be a collectable sticker eg for placement in an album.

Before looking further at the overall functions and benefits which the described embodiments of the invention provide, there is a need to look at some of the mechanical relationships which are evident from the above, after considering the drawings, but which may not be immediately easily seen otherwise. For example there is the question of the separation of the first and second label portions, when the former is caused to be peeled (or otherwise selectively removed) from the product, in use of same.

In the embodiment, the reason why the first and second label portions separate is that there is a differential adhesiveness as between the first and second label portions and the product itself, whereby the label portions do separate, as required. It will be understood that such separation of the label portions is affected by well-known physical adhesion and other factors (such as the angle of pull, when peeling-back), and such matters are well-known in the field concerned, and therefore we do not provide full data herein, since such matters rarely raise significant problems. Suffice it to say that in the embodiment, the arrangement is such that the intended peeling-back is achieved by a reasonable balance between adhesion and related peelability factors, not forgetting the separablility which is provided by the die-cut structure of the label web material, whereby the label portions are able to separate by virtue of the balance of adhesion and related functions discussed above. It may be desirable to employ a release coating in selected areas, for example over the die-cut peelable second label portions. Prior to separation, the label portions are linked by the label-portion-linking means provided by the first label portion, which is peelably (or otherwise separably) connected to the second label portion, and serves to hold the two label portions together for the purposes discussed above.

It will now be seen that the above-discussed embodiments of the invention offer a remarkable series of functions, which arise from the structures disclosed above, and which we will now summarise for ease of reference, and for purposes of definition of the invention, as follows.

Firstly, the invention provides according to one aspect thereof, a method of labelling, and a corresponding label therefor, in which first and second label portions are separably connected so that on separation, for example by peeling same apart, one or more portions of the label structure become accessible to the user or consumer, whereby additional data or information or otherwise desirable matter likewise becomes available or accessible to the user. The peelable (or otherwise separable) label portions may be arranged so that prior to separation, they are linked by a linking portion of same. Preferably the linking portion forms part of the first label portion, so that when peeled away it allows the label portions to separate independently. Preferably also the linking label portion is transparent or translucent at least in part whereby the second label portion can be seen through the first label portion, so that text, graphics or other matter can be seen by the user prior to commencing use. By arranging that the overlying arrangement makes available the data of, or makes visible or partially visible, the second label portion, or at least provides awareness of the existence of same, the embodiments enable the overall label structure to offer to the user the availability of additional functions or facilities, so that the label structure does significantly more than a simple identification label.

A further important optional feature of the invention is the overlying relationship of the first and second label portions. This feature enables the first portion to provide security or protection in relation to the separability of the second portion, and any related functions or information which may be associated therewith, such as lottery data or the like, prior to sale and/or use. Additionally the overlying relationship enables, in the embodiment, the first label portion to exert its cohesiveness function in terms of holding the label structure together prior to user-separation of the label portions. A related aspect of this function which likewise arises from the overlying relationship of the label portions is the tamper-evidence option, or at least the deterrence function in the sense of deterring any tendency for potential purchasers/users of the product to attempt to examine the data or information on the second label portion without purchase or prior to purchase of the product. This function arises at a secondary level from the fact that the overlying relationship of the label portions causes the first portion to protect the second portion (on which the data, such as lottery information, is printed) from examination by casual inspection of the product. Actual tamper-evidence can be provided by providing frangible elements linking the first and second label portions, so that actual partial or complete separation then becomes more clearly evident after the event.

An additional function which is a significant further optional feature of the invention is that the above features lead to an important advantage in relation to recycling of products carrying the invention, particularly products of the kind such as beverage containers, bottles and the like. In this regard, it is a significant fact that plastic bottles (and possibly other product containers of a related construction, or of a related functionality in relation to the requirements of recycling), are much more readily recycled if they have their labels removed before subjected to the recycling procedures. Therefore it would be a significant improvement in relation to products of the bottle kind and related products if some means could be found to assist with the problem of removing labels prior to subjecting such bottles to recycling. Certain embodiments of the invention offer improvements in relation to this problem by providing a label structure which, in use serves to encourage and even to cause (in particular product and user situations and environments) the user of the product to remove the label structure him/herself, as will now be explained.

By providing a label structure in which first and second label portions are separably provided on a single label structure, and with the facility to peel (or otherwise remove) the first label portion away from the second, while the latter remains on the product, but is then itself likewise removable by peeling or the like, the relevant embodiment enables the user to remove first the first portion of the label, and then the second such portion, for reasons connected with the intended use of the product, whereby the product itself (or more usually the empty container thereof) is rendered label-less by virtue simply of the user thereof carrying out the intended steps required for full utilisation thereof. In the embodiment, such intended steps consist of sequential removal of the label first and second label portions in order to (in accordance with an invitation on the product) gain access to the second label portion, and then to the under side of same, so that the hidden data thereon (relating to, for example, a lottery prize) can be accessed by the user.

Thus, to give an example from an embodiment of the invention, the label for a well-known cola-type product provides the usual product identification under conditions of normal use. Prior to consumer/user intervention, the label merely provides the usual identification of the product in an apparently conventional way.

However, at the suggestion of an invitation on the product itself, or on some accompanying literature, the user commences the steps of label removal in order to gain access to further information or data or to be able to enter a competition or the like. The two stages of label-portion removal (first and second label portions) follow one another in accordance with printed matter information on the product or its accompanying literature. After such removal, in the embodiment, the product is substantially free of labelling altogether, although such complete removal is certainly not a requirement of this aspect of the invention as it is most likely that significant benefits in relation to recycling can be obtained by removal of only at least a substantial portion of the label material from the product prior to recycling.

Of course it goes without saying that in many a case a user may not actually get round to removing both label portions completely (due to any number of extraneous factors) prior to recycling, particularly as such is, in principle, not related to recycling in any direct way, but only as a beneficial consequence of the label structure and an available mode of use of same.

One aspect of the present application relates to the mode of construction of the label having regard to the material used for the label itself, and the physical requirements imposed on the label by its intended use, such as use in relation to carbonated beverages.

An example of a label construction intended for use in relation to bottles of carbonated beverage is the label disclosed in WO 00/19395 (Scott, Leonard James), which provides (Summary of the invention, page 1), a composite label including a first layer of printed polyester, and a second layer having a density less than the polyester. The polyester layer is for displaying information at a first surface of the label, and the second layer is for presenting information at a second surface of the label.

The WO 395 specification states that a label having a simple double layer construction of laminated paper is disclosed in PCT/US97/18837, and that such a label is considered to be cost effective and sufficiently robust for use with tinned produce or the like, but that there has not been any suitable application of such a label to the soft drink industry where material thickness and reliable application of the label is of paramount concern.

In fact, the disclosure in the PCT 837 specification relates to a label or wrapper with “premiums” or stickers to add value. The premiums are integral with the label material so that the latter has uniform thickness for automated application to products, and are produced at the time of label printing, on the front or back face of the label. FIG. 1 shows the label applied to a beverage bottle. FIG. 5 shows a multi-layer construction. Die cuts extend through a part of the thickness of the label to define the removable stickers. Claim 13 specifies “paper” for the material of the label, and Claim 14 specifies “printable polymeric material” for the label.

Thus, in contradistinction to this known label construction, the WO 395 specification provides a composite label of polyester and (preferably) polypropylene. This specific composite construction is stated to have a number of advantages over the known construction of the PCT 837 specification due (page 2, line 5) to the comparative density of the polyester relative to the polypropylene, whereby the depth of the label may be minimised, while strength is maintained, and due also to the ability of the polypropylene to be readily cut or scored due to its relative softness, so as to define a removable portion of the label, without compromising the integrity of the polyester layer. In a specific embodiment of the WO 395 specification, the polypropylene layer comprises BOPP (biaxially orientated polypropylene) in combination with PET (polyethylene terephthalate).

We have carried out research into the requirements of bottle labels such as those of the kind disclosed in the WO 395 specification, and we have identified various shortcomings of the disclosures of the prior art, including the WO 395 specification, notably including an unsuitability for use in certain countries due to the climatic conditions, particularly extreme temperature rise, such as arises when pallets of beverage bottles have to be stored in sunshine, or otherwise in very hot conditions. These shortcomings can be of considerable significance, since they include an inability to tolerate normally-encountered temperatures, leading in some cases to compromising of the label integrity and splitting or breakage of same.

In the case of beverages, particularly carbonated ones, which are produced or are distributed on a world-wide basis, there are certain physical requirements arising currently in relation to the use in the labelling system of polymeric film or sheet materials, which hitherto have not been well appreciated, in the absence of a careful study of the effect on same of the nature of the product and its physical attributes, including not only the beverage itself, but also its container.

In this context, whereas the approach adopted in the WO 395 specification is to seek to match the label to its container, the modern bottle for carbonated beverages, which frequently comprises PET, and thus to adopt as the starting point for the construction of the label, the use of PET itself as one main layer of the label, no doubt on the basis that if PET is suitable for the bottle itself it can hardly fail to be suitable for the label, or at least as one layer of the label. However, our research shows that although PET (and possibly other polyesters) can be used for such labels, at least for certain markets, these materials actually do not meet the requirements of the international drinks market in view of several significant technical factors discussed below, including the fact that the requirements of a label for a beverage container differ significantly from those of the container itself, notably in a requirement for an ability to accept quite a high level of stretch, such as occurs when a bottle of carbonated beverage is stored for any length of time at high temperatures in sunshine, whereby both the beverage and its surrounding atmosphere of pressurised gas expand the somewhat flexible bottle, and cause its (inevitably tight-fitting) surrounding label to have to stretch significantly;

We have discovered that although PET's physical characteristics may well suit it for the material of the bottle for carbonated drinks, it is not ideally suited for use as a label for the bottle because its elasticity does not well adapt it to stretch when the bottle expands;

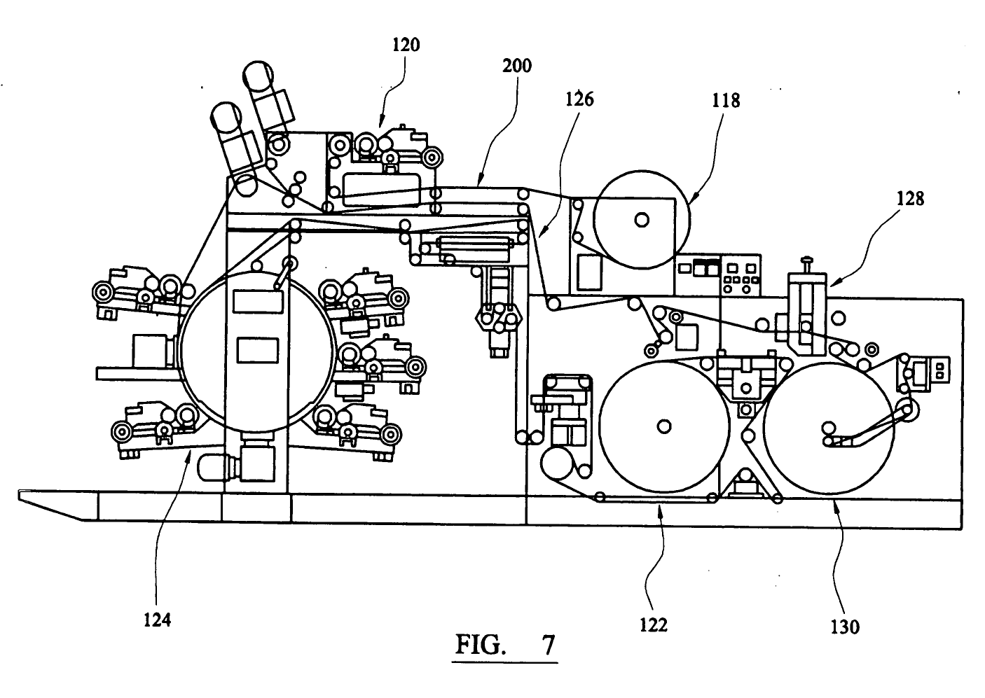

We have also discovered that the stretch characteristics of the PET material are not the only factor militating against its adoption as a labelling material for carbonated beverages world-wide. Another factor concerns the question of die-cutting or scoring the label web during the production process. This is discussed in the WO 395 specification, and it is stated that it is necessary, in accordance with the invention, to adopt the use of a material of lower density than the PET (preferably BOPP) in order that the scoring (to enable the customer-exercisable option to sever or separate a label portion) can be exercised without unacceptable damage to the PET and the label as a whole. This is discussed in relation to FIG. 6 of WO 395 where a region 42 of the PET resists a cutting action indicated by arrow 43.

Our research shows that, on the contrary, the adoption of the PET material as the basis of the composite label introduces severe physical limitations in relation to the use of the label in high-temperature latitudes, and indeed, there is no need to adopt a composite label structure, such as PET/BOPP, since a very satisfactory result can be obtained with the use of chemically homogeneous label layers, based on a single polymer, of which one preferred example is BOPP itself. In other words, we have discovered that in fact a technically improved result can be obtained by the adoption of a non-composite polymeric film material, based on the use of a single polymer, such as polypropylene (PP). Our research has shown that such a material in fact exhibits a significantly enhanced package of physical and chemical properties in relation to the requirements of the soft drinks (and indeed beers and other carbonated alcoholic drinks) bottling industry, where plastic bottles are used, especially where the bottles may (at least occasionally) be subjected to high temperatures and/or sunshine.

Thus our research shows that:

a) a non-composite label, such as a label based on polypropylene for both (or all) layers of the label, has considerable merit; and

b) the use of a polymer for the label, which need not (or indeed preferably should not) be based on the polymer used for the bottle itself, likewise has merit. This is not least due to the fact that the physical requirements of the bottle differ remarkably from those of the label itself, not just in terms of the obvious requirement for an ability to withstand the strength requirements arising from the gas-pressurisation of the bottle itself, but also from the stretch requirements imposed on the label and caused by the expansion of the bottle under warm or high temperatures; and

c) that there is likewise considerable economic merit in the use of a one-pass manufacturing system for the production of the labels, such as can be achieved by use of the label presses of Ko-Pack International Corp., since the one-pass approach greatly simplifies and reduces costs in this essentially low-cost step in the production of these high-volume (meaning large numbers of the product) consumer products; and

d) that by the adoption of presses for the label manufacture having a level of accuracy (in relation to such operations as die-cutting and scoring), which permits such operations to be dimensionally controlled to the degree necessary for the avoidance of cut-through and bruising illustrated/discussed in relation to FIG. 6 of the WO 395 specification, without needing to resort to the use of defined polymers (such as PET and polypropylene) as constituents for the specific layers of the label;

e) such an approach (as discussed above in items a) to d) enables an approach to be adopted to the manufacture of labels suitable for use in relation to the bottling in plastic bottles and the like of carbonated beverages, which is of commercial significance, in that label cost and label thickness are minimised, thereby meeting the needs of the beverage manufacturer, and these requirements are met in a relatively straightforward way without adopting exotic materials for the manufacturing process, but indeed being able to use a known material (such as polypropylene) which is at the minimum cost end of the manufacturing materials scale.

Where the approach of the present invention adopts a “homogeneous” polymeric material, as opposed to the “composite” polymers adopted in the WO 395 specification, an example of such a homogeneous polymer is polypropylene itself, as opposed to the use of PET in combination with polypropylene. In this connection we have discovered that the use of polypropylene (PP) in differing densities for the two layers of the embodiments of the present invention has technical advantages. Thus by using higher density PP for the label layer which will form the outer layer in use, and a lower density PP for the inner layer, the manufacturing process is facilitated, and the well-defined separation of the die-cut or scored, and non-die-cut or scored layers is achieved (particularly if the use is adopted of the Ko-Pack presses mentioned above), and without the need for the use of three or more layers of sheet material (usually film) in the label structure, as has been found to be necessary, we are aware, in the research into labels of this kind by other parties;

Another advantage of the use of higher and lower density PP in this way, we have found, (and which may well be applicable to other polymeric sheet materials), is that it permits the lower density to be achieved (or assisted) by the use of an opaque PP sheet in which the opaqueness is produced or assisted by the incorporation into the PP of microbubbles of gas, such as air, which in itself reduces the density, and provides for visual separation of the graphic matter which is printed on opposite sides of the PP sheet, or which is printed in front of and behind the layer (if such is adopted) of gas bubbles in the PP;

Overall therefore, the methods of the present invention provide an approach to the manufacture of labels for application to beverage bottles, particularly bottles for carbonated beverages to be marketed on an international scale, permitting the use of promotional schemes involving detachable adhesive portions and the like, in an economic and cost-effective manner, and taking an approach to the manufacturing steps which in several important respects is the converse or opposite of that adopted in the WO 395 specification;

Moreover, the embodiments of the present invention offer an approach to the actual physical form of such a label which differs significantly from those described in the WO395 specification, in that the adhesive stickers which the bottle-user is offered when the label on the bottle is detached from the bottle, are interestingly and attractively disposed on the bottle itself at defined locations for subsequent removal at the user's leisure; and the removal of the bottle label from the bottle by the user in order to give access to the adhesive stickers produces the result that the entire label structure (apart from the adhesive stickers) is removed from the bottle, thereby making the latter suitable for recycling, since the adhesive stickers are likely to be removed by the user later anyway, in the course of using them in the intended way.

Thus, according to one aspect of the invention, there is provided: a label assembly adapted to be applied to a beverage container such as a bottle. The label assembly is likewise adapted to encircle the bottle, in use. At least one removable label portion is provided, which is adapted to be peeled or otherwise separated from the remainder of the label so as to enable a user to gain access to information or other matter, such as information relating to a game of chance. The first and second label portions are disposed, in use of the label, in superimposed laminar assemblage. In one preferred embodiment, these label portions each provide their own complete encircling label element around an external profile of the bottle, one encircling the other. In another embodiment, at least the outer label element, provides a complete encircling label element, and is provided with user-actuatable means, such as one or more tear lines or the like, to enable the user to commence peeling or otherwise removing a portion of the outer label element. The said outer label element comprises a polymeric film or sheet material comprising a polymerised unsaturated hydrocarbon (such as polypropylene) having a coefficient of tensile flexibility greater than that of the corresponding polymerisedester (or polyester), such as polypropylene (or polyethylene) terephthalate, whereby the label element has an absolute extensibility under conditions of use of the label in relation to bottles of carbonated beverage sufficient for the label element to be able to elastically extend to accommodate the expansion of the bottle under conditions of expansion of same under conditions of high ambient temperatures such as occur in extreme summer conditions, without compromising the integrity of the user-actuatable means, such as one or more tear lines or the like, to enabel the user to commence peeling or otherwise removing a portion of he outer label element, even after significant expansion of the beverage container under such relatively high-temperature conditions as affecting the pressure of the carbonated beverage.

An aspect of the present invention relates to the nature and choice of polymers for the film or sheet material of the label assembly. Whereas the prior art teaches the use of certain specific polymers for labels of the kind with which the present invention is concerned, and, as indicated above, those polymers have certain operational characteristics and shortcomings so far as an ability to sustain the requirements of the products in use is concerned, we have discovered, and according to the present invention seek to claim as an aspect of the present invention, the use of the polymeric materials which our research has identified as providing the means for overcoming the limitations and shortcomings of the prior proposals, in accordance with the following statements.

Thus, we provide in accordance with an aspect of the present invention, a label assembly of the kind discussed above, comprising one or more peelable or otherwise removable partially or totally detachable portions, wherein the polymeric material adopted for the label elements in order to meet the requirement for an ability to withstand the high levels of tensile stress imposed by the high temperature conditions discussed above, is not the use of high-strength and relatively high cost material such as the PET material taught by the prior art, and used in relation to the high strength-requiring function of the carbonated beverage bottles themselves, but instead the present invention teaches the use of relatively low cost and nominally not high-strength materials such as basic unsaturated hydrocarbon polymers, such as polypropylene or possibly polyethylene (as opposed to the corresponding terephthalate esters) as the basis for the label films or sheet materials, since we have found that contrary to expectations these materials have the necessary properties in terms of an ability to stand the expansion of carbonated bottle which occurs under conditions of (relatively) high temperatures which raise significantly the internal gas pressure in the bottle and cause a corresponding slight expansion of the bottle (to the extent permitted by the polymer of the plastic bottle itself) which requires a corresponding physical response from the label elements themselves. Our research has identified the fact that the best combination of physical properties for meeting these requirements together with an associated acceptable cost from the production point of view is provided by polypropylene film materials of differing density, namely regular and low density films of such to fulfill the outer and inner label elements respectively. Tests show that these film materials are able to offer a level of elastic stretch to accommodate the above-discussed temperature-and-pressure induced bottle expansion, without any effect on their tensile strength sufficient to prejudice their functional ability in relation to these bottle-labelling uses.

A further aspect of the invention provides a method of labelling a beverage bottle. The method is applied to a bottle adapted to contain a carbonated or otherwise pressurised beverage. The label applied to each bottle in the method comprises at least one partially or fully-removable label portion, such as a sticker or other promotional device. The removable portion is rendered removable by the provision of removal means comprising a printed or otherwise marked or identified tear or cut-line or like device, The label is thus constructed so as to be able to permit simple removal of the removable portion while being able to resist the tension and related effects of the expansion of the bottle on which the label is mounted in use, under the effect of the carbonated beverage within same, and the effect of temperature rises of the bottle and its contents on the gas pressure within the bottle, and likewise the tensions arising during the bottle-labelling process itself, by the construction of the label comprising, at least in the outer or upper layer of the label, a polymer having an index of tensile extensibility value which is greater (in the sense of permitting greater extensibility per unit extension-causing load applied thereto) than the corresponding extensibility of the bottle itself.

We have discovered that by the use of the above-identified approach to the choice of materials to be used in the identified bottle-labelling process or method, is to cause the label to respond in use to the label-loading by a stretching step, which enables the label to be able to survive the tensile load applied to it, without breakage.

In contrast, the approach taken in the prior art is to say that it is obviously necessary, in order to prevent the label from breaking in use, in such cases, a polymer at least as strong as the polymer employed in the construction of the bottle itself. The result of the opposite approach adopted by the present invention is (as mentioned above) to cause the label to respond in use to the label-loading by a stretching step, which (contrary to the approach adopted in the prior art) allows the bottle to rely on its own strength for its own requirements without using the label as a reinforcing element serving to provide an additional reinforcing band against which, inevitably, the very substantial forces causing expansion inevitably are set.

In an embodiment, the label comprises two label layers, including a transparent or transluscent top or outer layer, through which the printed matter or content of the label is viewed, and which serves to protect while rendering visible such matter in use, and, in addition thereto, a bottom or inner layer, which serves to carry the printed matter of the label, and which is die-cut or scored to permit the removal of the selectively removable portions. The two label layers co-operate in use. The outer layer serves to protect and render the inner layer visible to the user, while providing overall cohesiveness regardless of whether the label and its component portions are held in place by the application of peelable adhesive just to selected locations of the overall label assembly, or more widely thereto so at to cause the label to need to be peeled more extensively for removal. The inner layer provides the user's enticement to investigate the promotional matter printed thereon and offers its die-cut stickers or the like for this purpose, thereby rendering the label assembly commercially attractive as an adjunct to an already marketable product. Structurally, the two label layers form a unitary assembly which offers much to the product manufacturer seeking a means for identification of a product together with user-attracting sub-features which, in their own way, provide supporting commercially-enhancing aspects of the overall product package which the intending purchaser may well find just sufficient to push him or her into buying that product instead of the adjacent product.

By providing a label which can meet the requirements of product identification and user-involvement and interest, while not requiring the use of relatively expensive materials and yet offering convenient application to a wide variety of products, and notably allowing the product manufacturer to meet the requirement for a bottle label which can stand up to the physical test imposed by extreme summer heat applied to a carbonated beverage in plastic bottles of the kind which allow a significant degree of expansion in a temperature/gas-pressure responsive manner, and likewise under the tension applied during the label-applying process during bottling. Such conditions otherwise can result in a product with labels which include numerous examples of label-rupture or partial rupture under the tension induced.

A still further aspect of the invention, which relates more to the concept of providing for placement of peelable label portions on a product such as a beverage bottle, than to matters discussed immediately above, is the label and corresponding method identified as follows. According to this aspect of the invention, there is provided a peelable label for a beverage bottle or other product, which, when peeled, leaves peelable stickers or the like in defined places on the product.

The invention also provides a corresponding method for placement of peelable label portions on a product such as a beverage bottle, comprising the steps of applying a label assembly to such product, peeling a first label portion therefrom, such first peeling step causing said first and outer label portion to be removed, while leaving adhered to the product at least two peelable spaced second label portions, and the method comprising the optional subsequent step of peeling from the product (for application to a further article such as a sticker album, or to reveal text and/or graphics of interest or advantage to the user) at least one of said spaced second label portions.

Embodiments of the invention will now be described by way of example with reference to the accompanying drawings, in which:

FIG. 1 shows a plan view of a portion of a label forming a first embodiment of the invention; and

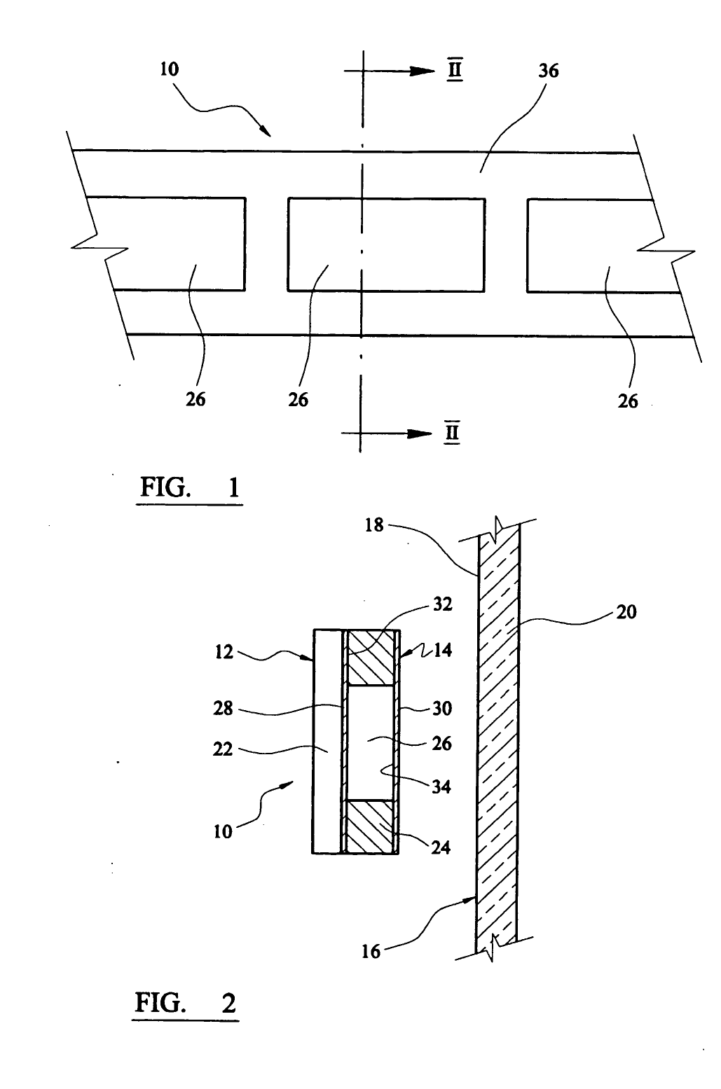

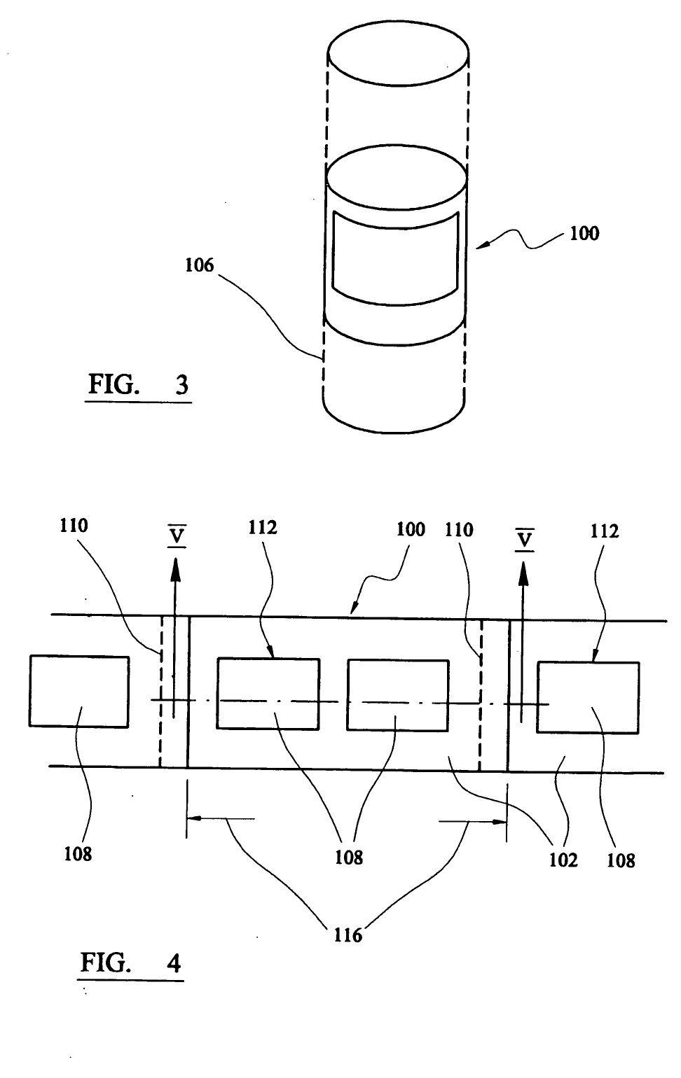

FIG. 2 shows a cross-section through the label of FIG. 1 on the line II-II in FIG. 1, and showing the general structure of the label in terms of the label portions which form the label components; and

FIG. 3 shows a second embodiment, and provides a perspective view from above, of this label embodiment in generally cylindrical format as applied to a beverage bottle; and

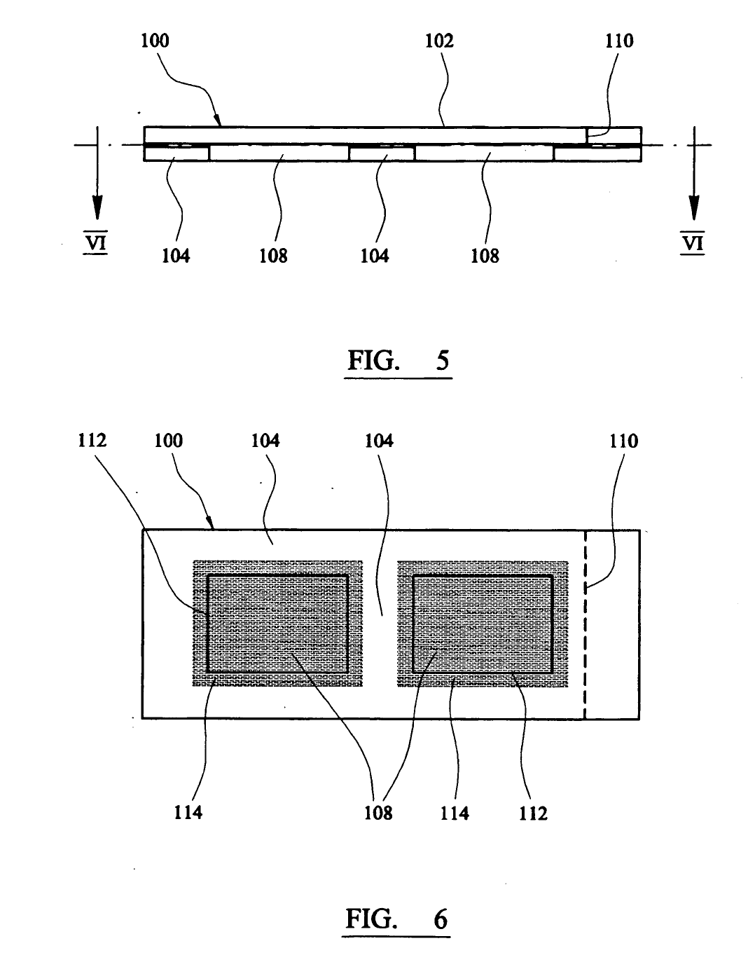

FIG. 4 shows a plan view of part of a label strip or web, and indicating the length of one complete label, and the broken lines showing where the user may cut or otherwise sever the label, so as to peel-back the outer portion of the label in use; and

FIG. 5 shows a cross-section on the line V-V in FIG. 4, this section showing, diagrammatically in terms of the proportions of the component parts of the label, the two main label portions or webs forming the laminar assembly of the label, and the peelable sticker or label which is die-cut into the inner label portion and which remains adherent to the product labelled (the bottle) after peeling the outer label portion; and

FIG. 6 shows an internal plan view of the assembly of FIG. 5, the view being taken at the level indicated by the arrows VI-VI in FIG. 5, to enable an indication to be provided of the extent of the areas of silicone release agent treatment in relation to each of the peelable second label portion areas; and

FIG. 7 shows a side elevation view of a label-making press for assembling and printing the labels of the preceding embodiments.

Considering first, the embodiment of FIGS. 1 and 2 of the drawings, as shown in FIGS. 1 and 2, a label 10, is intended for use in relation to the labelling of a product such as a bottle of a cola-style beverage, being in this case of sufficient length to extend around the periphery of the beverage bottle (not shown).

In the drawings the mode of representation of the label web is somewhat diagrammatic in order to show the generalities of the structure with clarity. Thus, for example, it needs to be understood that the body of the label comprises conventional label web materials such as paper or synthetic polymeric materials, or indeed hybrid materials may be available and suitable for certain applications. Accordingly it will be understood that the proportions of the label web materials in terms of their thickness in relation to their other dimensions are not to be taken as indicative of actual dimensions, but only as indicating the general structure of the label, and the overall dimensions and proportions of the label are generally in accordance with established practice, as the practice of the present invention does not affect those practical issues to any great extent.

Accordingly the length of label 10 is such as to extend around a bottle of cola or other beverage to which it relates (by identifying that product), with, perhaps a small degree of overlap, in the usual way, where the label ends meet each other.

Label 10 comprises a front side 12 and a rear side 14. Front side 12 faces outwards in use, and rear side 14 faces inwards towards product 16 (shown in cross-section and only a portion thereof) in the form of a moulded plastic beverage bottle 18, having side walls 20, to the outside of which label 10 is to be applied.

Label 10 comprises two main elements, namely a front transparent cover web 22, and a rear, printed web 24 formed with die-cut regions 26, which in this embodiment are of generally rectangular format. The two main elements of the invention are however inter-related in a manner not immediately apparent from the above general structure, as will now be explained.

There is applied to the rear face of cover web 22 a layer 28 of peelable adhesive and a corresponding layer 30 of adhesive is applied to the rear face of printed web 24 for a purpose to be described below.

Printed matter is provided on both faces of printed web 24. The printed matter on its front face 32 is visible to users through transparent cover web 22 and through adhesive layer 28. The printed matter on the rear face of web 24 is only accessible and visible for reading purposes after a further peeling operation, to be described below.

In use, label 10 is adhered to bottle 18 through adhesive layer 30, and serves to identify the product by virtue of the printed matter on the front face 32 of web 24, and which is visible through transparent cover web 22. Then the user is caused to decide to remove a portion of the label to gain access to another portion thereof. As discussed above this is achieved by means of publicity material, which may be printed on the label, or it may be available in addition or as well in the form of an invitation to inspect the reverse or adhered face 34 of the die-cut regions 26 so as (for example) to have the opportunity to win a prize. In order to gain access to the face 34, the publicity material invites the user to peel back the outer or top layer of the label 10, namely cover web 22, in order to take the essential first step.

The first step for this purpose comprises, an mentioned, peeling back the cover web 22. This step causes the following. Because cover web is adhered to rear, printed web 24 formed with die-cut regions 26, the effect of such peeling action is to peel away not only the transparent cover web 22, but also the outer web-portion 36 surrounding the die-cut regions 26, thus leaving those die-cut regions adhering to the bottle 18 at spaced locations thereon.

It can now be seen that the portions of label 10 which separate as above for the purposes described, constitute first and second label portions for the purposes of the invention. Thus the first portion of the label comprises the cover web 22 and the outer web-portion 36, and the second portion of the label is provided by the die-cut regions 26.

After the first label portion 22, 36 has been peeled away, the second such portion 26 can then be peeled away (because it is now no longer covered by the first portion) to reveal the printed matter on the undersides of the second portions, which will enable the user to enter a competition or else to do something else connected with the product 16 in accordance with the information relating thereto.

Turning now to the embodiment of FIGS. 3 to 7 of the accompanying drawings, this embodiment of the invention serves to illustrate the mode of construction of the label having regard to the material used for the label itself, and the physical requirements imposed on the label by its intended use, particularly use in relation to carbonated beverages, but not least by its rather particular label structure (a die-cut or otherwise weakened, laminar structure, “dcwls” hereafter), including the use of inner and outer label laminar webs or portions, which are separable in order to enable the user to (for example) remove a sticker or the like, and at least one of which includes die-cuts or perforations or the like, which affect its strength in tension. It will be noted that in this and other general structural features, the labels described below conform to the structural features already described above in relation to FIGS. 1 and 2, and the description below thus relates to additional aspects of the material and other specifications of the labels.

As indicated above, our research shows that, a very satisfactory result can be obtained by the use of what may be termed chemically homogeneous label layers, based on a single polymer, of which one preferred example is BOPP itself. In other words, we have discovered that in fact a technically improved result can be obtained by the adoption (for this dcwls label structure) of a non-composite polymeric film material, based on the use of a single polymer, such as polypropylene (PP). Our research has shown that such a material in fact exhibits a significantly enhanced package of physical and chemical properties in relation to the requirements of dcwls labels for the soft drinks (and indeed beers and other carbonated alcoholic drinks) bottling industry, where plastic bottles are used, especially where the bottles may (at least occasionally) be subjected to high temperatures and/or sunshine, provided that certain requirements are met.

Thus, in accordance with such research, this embodiment provides:

a) a non-composite label 100, such as a label based on polypropylene (PP) for both (or all) layers of the label, has considerable merit; and

b) the use of a polymer for the label, which need not (or indeed preferably should not) be based on the polymer used for the bottle itself, likewise has merit. This is not least due to the fact that the physical requirements of the bottle differ remarkably from those of the label itself, not just in terms of the obvious requirement for an ability to withstand the strength requirements arising from the gas-pressurisation of the bottle itself, but also from the stretch requirements imposed on the label and caused by the expansion of the bottle under warm or high temperatures; and

c) that there is likewise considerable economic merit in the use of a one-pass manufacturing system for the production of the labels, such as can be achieved by use of the label presses 200 (see FIG. 7) of Ko-Pack International Corp., since the one-pass approach greatly simplifies and reduces costs in this essentially low-cost step in the production of these high-volume (meaning large numbers of the product) consumer products; and

d) that by the adoption of presses 200 for the label manufacture having a level of accuracy (in relation to such operations as die-cutting and scoring), which permits such operations to be dimensionally controlled to the degree necessary for the avoidance of cut-through and bruising illustrated/discussed in relation to FIG. 6 of the WO 395 specification, without needing to resort to the use of defined polymers (such as PET and polypropylene) as constituents for the specific outer and inner layers 102 and 104, respectively, (see FIG. 5) of the label 100;

e) such an approach (as discussed above in items a) to d) enables an approach to be adopted to the manufacture of labels 100 suitable for use in relation to the bottling in plastic bottles 106 (shown partially, just the cylindrical main body portion of the bottle, in FIG. 3) and the like of carbonated beverages, which is of commercial significance, in that label cost and label thickness are minimised, thereby meeting the needs of the beverage manufacturer, and these requirements are met in a relatively straightforward way without adopting exotic materials for the manufacturing process, but indeed being able to use a known material (in this embodiment polypropylene) which is at the minimum cost end of the manufacturing materials scale.

Thus in this embodiment,the present invention adopts a “homogeneous” polymeric material for the layers or webs 102, 104, in this embodiment such homogeneous polymer being polypropylene (PP) itself. In this connection we have discovered, as noted above, that the use of polypropylene (PP) in differing densities for the two layers of the embodiments of the present invention has technical advantages which are of particular significance in relation to labels of the “dcwls” (as identified above) kind. Thus by using higher density PP for the label layer 102 which will form the outer layer in use, and a lower density PP for the inner layer 104, the manufacturing process is facilitated, and the well-defined separation of the die-cut or scored layer 104, and non-die-cut or scored layers 102 is achieved (and facilitated by the use of the Ko-Pack presses 200 mentioned above), and without the need for the use of three or more layers of sheet material (usually film) in the label structure, as has been found to be necessary, we are aware, in the research into labels of this kind by other parties;

Another advantage of the use in this embodiment of higher and lower density PP (as exemplified by the layers 102 and 104) in this way, we have found, (and which may well be applicable to other polymeric sheet materials), is that it permits the lower density to be achieved (or assisted) by the use of an opaque PP sheet 104 in which the opacity is produced or assisted by the incorporation into the PP of microbubbles of gas, such as air, which in itself reduces the density, and provides for visual separation of the graphic matter which is printed on opposite sides of the PP sheet, or which is printed in front of and behind the layer (if such is adopted) of gas bubbles in the PP;

Overall therefore, the methods of the present embodiment provide an approach to the manufacture of labels for application to beverage bottles, particularly bottles 106 for carbonated beverages to be marketed on an international scale, permitting the use of promotional schemes involving detachable adhesive portions and the like, in an economic and cost-effective manner.

Moreover, the present embodiment of the invention offers an approach to the actual physical form of such a label which differs significantly from those described in the WO395 specification, in that the adhesive stickers which the bottle-user is offered when the label on the bottle is detached from the bottle, are interestingly and attractively disposed on (and peelably adhered to) the bottle 106 itself at defined locations for subsequent removal at the user's leisure; and the removal of the bottle label outer portion 102 from the bottle 106 by the user in order to give access to the peelable adhesive stickers 108 produces the result that the entire label structure (apart from the adhesive stickers 108) is removed from the bottle 106, thereby making the latter suitable for recycling, since the adhesive stickers are likely to be removed by the user later anyway, in the course of using them in the intended way.

Thus, referring now to the concepts discosed in FIGS. 3 to 6, there is provided: a label assembly 100 adapted to be applied to a beverage container such as a bottle 106. The label assembly 100 is likewise adapted to encircle the bottle 106, in use, as indeed is shown in FIG. 3. At least one removable label portion 102 (the outer label portion), together with the peelable stickers 108, are provided, which are indeed adapted to be peeled or otherwise separated from the remainder 104 (the rear or inner label portion) so as to enable a user to gain access to information or other matter (being the text or graphics printed on the sticker), such as information relating to a game of chance. The first and second label portions 102 and 104 are disposed, in use of the label, in superimposed laminar assemblage. In the preferred embodiment, as shown in FIGS. 3 to 6, these label portions 102, 104 each provide their own complete encircling label element around an external profile of the bottle 106, one encircling the other.

In another envisaged embodiment, at least the outer label element 102, would provide a complete encircling label element, and would be provided with user-actuatable means, such as one or more tear lines 110 or the like, to enable the user to commence peeling or otherwise removing at least a portion (but in this embodiment, all) of the outer label element. The said outer label element 102 comprises a polymeric film or sheet material comprising a polymerised unsaturated hydrocarbon, or polyolefin, (such as polypropylene) having a coefficient of tensile extensibility greater than that of the corresponding polymerisedester (or polyester), such as polypropylene terephthalate (or polyethylene) terephthalate (from which, typically, the bottle will be made), whereby the label element has an absolute extensibility under conditions of use of the label, in relation to bottles of carbonated beverage, sufficient for the label element to be able to elastically extend to accommodate the expansion of the bottle 106 under conditions of expansion of same under conditions of high ambient temperatures such as occur in extreme summer conditions, without compromising the integrity of the user-actuatable means, such as the one or more tear lines 110 or the like, to enable the user to commence peeling or otherwise removing a portion of the outer label element 102 even after significant expansion of the beverage container under such relatively high-temperature conditions as affecting the pressure of the carbonated beverage.

There is thus provided in the embodiment of FIGS. 3 to 7, in accordance with an aspect of the present invention, a label assembly 100 of the kind discussed above in relation to FIGS. 1 and 2, comprising one or more peelable or otherwise removable partially or totally detachable portions 102 and 108, wherein the polymeric material adopted for the label elements 102 and 104 in order to meet the requirement for an ability to withstand the high levels of tensile stress imposed by the high temperature conditions discussed above, is not the use of high-strength and relatively high cost material such as the PET material taught by the prior art, and used in relation to the high strength-requiring function of the carbonated beverage bottles 106 themselves, but instead the present embodiment provides the use of relatively low cost and nominally not high-strength materials in the form of the basic polyolefin (unsaturated hydrocarbon polymers), in the form of polypropylene (as opposed to the corresponding terephthalate ester) as the basis for the label films or sheet materials.

A further aspect of the invention relates to a method of labelling a beverage bottle, and is likewise shown and illustrated in FIGS. 3 to 7. The method is applied to bottle 106 which is, as noted above, adapted to contain a carbonated or otherwise pressurised beverage. The label 100 applied to each bottle in the method comprises at least one partially or fully-removable label portion 108, in the form of a sticker or other promotional device. The removable portion 108 is rendered removable by the provision of removal means comprising tear-line or device 110 (for removing the first and outer label portion 102), giving access to the inner part of the label and to the die-cut edges 112 defining stickers 108, both of which have the effect of tending to lessen the overall tensile strength of at least that portion of the label in which those features are provided (and thus of the overall label assembly), at least partially.

The label 100 is itself constructed so as to be able to resist the effect of such lessening of tensile strength on the ability of the overall label to withstand the effect of the expansion of the bottle on which the label is mounted in use, under the effect of the carbonated beverage within same, and the effect of temperature rises of the bottle and its contents on the gas pressure within the bottle, by the construction of the label 100 comprising, at least in the outer or upper layer 102 of the label, a polymer having an index of tensile extensibility value which is greater (in the sense of permitting greater extension per unit extension-causing load applied thereto) than the corresponding extensibility of the bottle 106 itself.

We have discovered that by the use of the above-identified approach to the choice of materials to be used in the identified bottle-labelling process or method, we can cause the label to respond in use to the label-loading by a stretching step, which enables the label to be able to survive the tensile load applied to it, without breakage.

The result of the approach adopted by the present invention is (as mentioned above) to cause the label 100 to respond in use to the label-loading by a stretching step, which (contrary to the approach adopted in the prior art) allows the bottle to rely on its own strength for its own requirements without using the label as a reinforcing element serving to provide an additional reinforcing band against which, inevitably, the very substantial forces causing expansion inevitably are set.

In the embodiment of FIGS. 3 to 7, the label comprises the two label layers 102 and 104, of which, outer layer 102 provides a transparent or translucent top layer, through which the printed matter or content of the label is viewed, and which serves to protect while rendering visible such matter in use, and, in addition thereto, bottom or inner layer 104 serves to carry the printed matter of the label, and which is die-cut at edge 112 defining stickers 108, to permit the subsequent removal by the user of those selectively removable portions. The two label layers 102 and 104 co-operate in use. The outer layer 102 serves to protect and render the inner layer 104 visible to the user, while providing overall cohesiveness regardless of whether the label and its component portions are held in place by the application of peelable adhesive just to selected locations of the overall label assembly, or more widely thereto so at to cause the label to need to be peeled more extensively for removal. The inner layer 104 provides the user's enticement to investigate the promotional matter printed at the underside thereof and offers its die-cut stickers 108 for this purpose, thereby rendering the label assembly commercially attractive as an adjunct to an already marketable product. Structurally, the two label layers 102 and 104 form a unitary assembly which offers much to the product manufacturer seeking a means for identification of a product together with user-attracting sub-features which, in their own way, provide supporting commercially-enhancing aspects of the overall product package which the intending purchaser may well find just sufficient to push him or her into buying that product instead of the adjacent competing product. Other features of the label assembly 100 seen in FIGS. 5 and 6 include the following. Firstly, the label's front portion 102 is transparent and comprises BOPP of density 0.895 grams per cubic cm, and of thickness 12 microns, whereas the rear or inner portion 104 in one embodiment is of density 0.553 grams per cubic cm, and in another embodiment is 0.627 grams per cubic cm, and of thickness 28 to 40 microns, the lower density of this layer of BOPP (by about 30% as compared with layer 102) being due at least in part to the inclusion in the BOPP of air microbubbles to give opacity for printing purposes. The rectangular die-cut areas 112, defining stickers 108, are overprinted with slightly larger patterned areas 114 of (for example) silicone release agent, to facilitate the peeling back of the outer label portion 102, while leaving the inner label portion or stickers 108 in position adhered to the bottle 106 at locations defined by the spacing of the stickers on the label 100. The overall length of label 100 is indicated in FIG. 4 by the dimension arrows identified by numeral 116.

Turning now to the embodiment (in terms of manufacturing labels) of FIG. 7, it will be seen that label press 200, carries out the production of labels 100 in a continuous web for use by bottling companies in terms of application of the labels to beverage bottles at high speed during or after the bottle-filling process. The press 200 uses as its starting materials basic polymer film, as previously described, together with the basic other production materials including printing ink, adhesive, release medium, and other supplies (known to those skilled in the art).

The press 200 itself is of the kind available from Ko-Pack Corporation, of Japan, and is available in various specifications, according to customer requirements, the press illustrated in FIG. 7 being merely illustrative. The most significant point from the commercial/technical point of view being that the press (whatever its detailed specification) will be able to carry out the label web assembly and die-cutting steps at the required level of high speed and quality with economy, as is a requirement of this high-volume/low margins commercial operation.

Thus, as shown in FIG. 7, press 200 effects unwinding of a drum of the transparent 12 microns top layer (102) film of higher density BOPP, at 118, and this film is then subjected to a step of ultra-violet-finished release material application at 120, to produce the areas 114 of release material seen in FIG. 6.

The roll 122 of lower density white opaque BOPP for the 28-40 microns lower or inner layer 104 of label assembly 100 feeds this web to a five-station printing drum 124 where a first stage of printing is carried out on one side of that web. In the case where it is required to print both sides of web 104, so that text or graphics for user/consumer attention is available on the underside of the stickers 108, as well as the product-identifying matter seen in FIG. 4 on the upper side thereof, then there will be provided in press 200 a second printing drum accordingly, and such will in fact usually be the case, and is readily accommodated within the press.

Lamination of the two label component webs 102 and 104 occurs at 126 and the other steps in the production process, including die-cutting at 128, are carried out in the proper sequence, as indicated, followed by winding at drum 130 of the label assembly on completion of the production process.

Interestingly, among the described embodiments there is provided a label which:

can easily meet the requirements of product identification, and

provides user-involvement and interest, such as offering double-sided stickers (printed both sides) with secure access to competition data or the like until the user peels the sticker;

causes the user to be likely to remove all of the label from the bottle (in the course of gaining access to the integral stickers), so that the bottle is thereby ready for recycling, and such stickers are then attractively displayed in terms of being adhered to the bottle in definded positions, ready for use by the consumer;

not requiring the use of anything other than basic inexpensive label production materials (webs/films) in a simple two-layer label assembly, and yet

allowing the product manufacturer to meet the requirement for a bottle label which can stand up to the physical test imposed by extreme summer heat as applied to a carbonated beverage in plastic bottles of the kind which allow a significant degree of expansion in a temperature/gas-pressure responsive manner, such conditions otherwise resulting in label-rupture or partial rupture under the tension induced;

capable of being produced at high speed and economical cost by use of appropriate label press technology, and

in a single pass through the press;

and using only two label webs, rather than the three or more which are required by other systems in order to achieve a comparable product;

also offering convenient application to a wide variety of other products.

What is claimed is:

1. A method of labelling comprising the steps of:
detachably applying a label, to a corresponding product the label including text and/or graphics inviting a user/consumer to detach a first portion of the label in order to gain access to a second portion of the label, said second portion of the label being likewise detachably applied to the product, and being initially protected from user access by said first portion of the label, and
providing on said second label portion text and/or graphics inviting the user/consumer to detach said second label portion in order to gain access to matter printed at an underside of said second portion of the label.

2. A method according to claim 1 wherein said product is a recyclable polymeric container for a beverage, and further comprising the step of substantially entirely removing the label from said beverage container, to render said beverage container fit for recycling.

3. A method according to claim 1, comprising the steps of:
providing said second label portion printed with text and/or graphics on both outer and inner faces thereof, and
providing said first portion with at least one of a transparent and translucent portion in order to provide a user/consumer with visual awareness of the second label portion.

4. A label assembly including text and/or graphics, comprising:
first and second portions;
the second portion adapted to be detachably applied to a corresponding product, said second portion including text and/or graphics inviting the user/consumer to detach said second portion in order to gain access to matter printed at an underside of said second portion of the label; and
the first portion overlying said second portion and adapted to be detachably applied to said corresponding product to protect said second portion from user access, said first portion inviting a user/consumer to detach the first portion of the label in order to gain access to the second portion of the label.

5. (canceled)

6. A label assembly adapted to be applied to a beverage container, said label assembly being adapted to encircle the beverage container, in use, the label assembly comprising a removable first outer label portion, which is adapted to be separated from a remainder second portion of the label assembly so as to enable a user to gain access to information on the second portion label portions being disposed, in use of the label, in superimposed laminar assemblage, at least the outer label portion providing a user-actuatable arrangement, to enable the user to commence removing a portion of the outer label portion, said outer label portion comprising a polymeric sheet material comprising a polymerised unsaturated hydrocarbon having a coefficient of tensile extensibility greater than that of a corresponding polymerisedester whereby the label assembly has an extensibility under conditions of use of the label assembly in relation to beverage containers which is sufficient for the label assembly to elastically extend to accommodate expansion of the beverage container under conditions of expansion of same under conditions of high ambient temperatures as affecting the pressure of a beverage in the beverage container.

7. A method of labelling a beverage container, said method comprising the steps of:
applying a label assembly to said container, said label assembly being adapted to encircle the container, in use, and comprising a removable first outer label portion, which is adapted to be separated from a remainder second portion of the label assembly so as to enable a user to gain access to information on the second portion, said step of applying including the step of applying said label assembly so that said first and second label portions are disposed, in use of the label, in superimposed laminar assemblage,
providing at least the outer label portion of said label assembly with a user-actuatable arrangement to enable the user to commence removing a portion of the outer label portion, and
providing said outer label portion with a polymeric sheet material comprising a polymerised unsaturated hydrocarbon having a coefficient of tensile extensibility greater than that of a corresponding polyester, whereby the label assembly has an extensibility under conditions of use of the label assembly in relation to beverage containers which is sufficient for the label assembly to elastically to extend to accommodate expansion of the beverage container under conditions of expansion of same under conditions of high ambient temperatures as affecting the pressure of a beverage in the beverage container.

8. A method of labelling beverage bottles adapted to contain a pressurised beverage, said method comprising the steps of:
applying a label to each bottle, said label comprising at least one at least partially removable label portion,
providing said removable label portion by a tear-line, and
providing said label itself constructed so as to be adapted to resist effects of expansion of the bottle by the construction of the label comprising, at least in an outer layer of the label, a polymer having an index of tensile extensibility value which is greater than a corresponding extensibility of the bottle itself.

9. A peelable label for a beverage bottle, which, when peeled, leaves peelable stickers in defined places on the bottle.

10. A method for labelling a product, comprising the steps of:
applying a label assembly to said product,
peeling a first outer label portion of said label assembly from said product, said peeling step causing said first outer label portion to be removed, while leaving adhered to the product at least two peelable spaced second label portions of said label assembly.

11. A method according to claim 10, wherein said product is in the form of a plastic beverage bottle, and further comprising the step of peeling from said bottle at least one of said spaced second label portions, so as to leave said bottle substantially ready for recycling.

12. (canceled)

13. A label assembly according to claim 4, wherein said second label portion is printed with text and/or graphics on both outer and inner faces thereof, and said first portion includes at least one of a transparent and translucent portion in order to provide a user/consumer with visual awareness of the second label portion.

14. A label assembly according to claim 6, wherein said information relates to a game of chance.

15. A label assembly according to claim 6, wherein said user-actuatable arrangement includes at least one tear line.

16. A label assembly according to claim 6, wherein said polymerised unsaturated hydrocarbon includes polypropylene, and said corresponding polymerisedester includes a material selected from the group consisting of polypropylene terephthalate and polyethylene terephthalate.

17. A label assembly according to claim 7, wherein said user-actuatable arrangement includes at least one tear line.
